(19) United States
(12) Patent Application Publication
(10) Pub. No.: US 2021/0291430 A1
(43) Pub. Date: Sep. 23, 2021

(54) AUTOMATED HEAT SHRINKING FOR A TELECOMMUNICATIONS PRODUCT

(71) Applicant: COMMSCOPE TECHNOLOGIES LLC, Hickory, NC (US)

(72) Inventors: Guadalupe Salvador CARRILLO ELIZALDE, Cuidad Juarez (MX); Jose Valentin MENDEZ GOMEZ, Cuidad Juarez (MX); Sergio Arturo VIZCAÍNO MARTÍNEZ, Cuidad Juarez (MX); Santiago CHAVEZ VIGUERA, Cuidad Juarez (MX); Jose CARBAJAL CRUZ, Cuidad Juarez (MX); Rogelio MENDOZA CHAVEZ, Las Aldabas (MX)

(73) Assignee: COMMSCOPE TECHNOLOGIES LLC, Hickory, NC (US)

(21) Appl. No.: 17/341,172

(22) Filed: Jun. 7, 2021

Related U.S. Application Data
(63) Continuation of application No. PCT/US2019/064714, filed on Dec. 5, 2019.
(60) Provisional application No. 62/776,808, filed on Dec. 7, 2018.

(51) Int. Cl. B29C 63/42; B29C 61/02; B29C 35/04

(52) U.S. Cl. CPC B29C 63/42; B29C 61/02; B29L 2031/3412; B29K 2995/0049; B29C 35/045

(57) ABSTRACT

A method for sealing a telecommunications product is disclosed. The method includes securing a telecommunications product to an apparatus having heat blasters, and initiating a heat sealing operation that includes moving the heat blasters along a first plane toward a shrink wrap tubing until the heat blasters surround the shrink wrap tubing; delivering hot air from each heat blaster; and moving the heat blasters along a second plane along a predetermined length of the shrink wrap tubing, the second plane being orthogonal to the first plane.

### CROSS-REFERENCE TO RELATED APPLICATION

This application is a Continuation of PCT/US2019/064714, filed on Dec. 5, 2019, which claims the benefit of U.S. Patent Application Ser. No. 62/776,808, filed on Dec. 7, 2018, the disclosures of which are incorporated herein by reference in their entireties. To the extent appropriate, a claim of priority is made to each of the above disclosed applications.

### BACKGROUND

Telecommunications closures are adapted to house and protect telecommunications components such as splices, termination panels, power splitters, and wave division multiplexers. In certain applications, the closures need to be water and contaminant (e.g., dust) proof and/or water-resistant. In particular, water, moisture, cleaning fluids, dust, etc. should be prevented from reaching components within the interior of the closures.

In certain applications, the closures include openings where telecommunications cables enter and exit the closures. During manufacture, these openings are sealed such as by using a shrink wrap tubing. Improvements are needed to increase production speed, the quality of the finished product, and to improve the safety of the working environment.

### SUMMARY

One aspect relates to a method for sealing a telecommunications product. The telecommunications product defines an interior space and at least one cable extends from the interior space to an exterior through an opening having a tubular body. The method comprises securing the telecommunications product to an apparatus, the apparatus including heat blasters each configured to emit hot air; positioning a shrink wrap tubing of a predetermined length over an outside surface of the cable and an outside surface of the tubular body of the opening; and initiating a heat sealing operation that includes moving the heat blasters along a first plane toward the shrink wrap tubing until the heat blasters surround the shrink wrap tubing; delivering hot air from each heat blaster; and moving the heat blasters along a second plane along a predetermined length of the shrink wrap tubing, the second plane orthogonal to the first plane. In some examples, the heat sealing operation includes delivering the hot air in a 360 degree direction around the shrink wrap tubing.

The method may further comprise delivering the hot air from each heat blaster according to a heat profile that varies the time the hot air is delivered along the second plane. The heat profile can include delivering the hot air at a constant temperature along the predetermined length of the shrink wrap tubing. The heat profile can further include delivering the hot air at about 100° C. to about 140° C. for a variable amount of time along the second plane. In one example, the heat profile includes delivering the hot air to a first section of the shrink wrap tubing before delivering the hot air to a second section of the shrink wrap tubing, the second section being farther away from the interior space of the telecommunications product than the first section. In another example, the heat profile includes delivering the hot air to the distal ends of the shrink wrap tubing for a first predetermined period of time, and delivering the hot air to central sections of the shrink wrap tubing for a second predetermined period of time, the first predetermined period of time being larger than the second predetermined period of time.

The method may further comprise using a clamp to secure the telecommunications product to the apparatus. The method may also further comprise using a clamp to secure the at least one cable to a frame of the apparatus.

The method may further comprise moving the heat blasters away from the shrink wrap tubing along the first plane; initiating a cooling operation; and removing the telecommunications product from the apparatus.

Another aspect relates to an apparatus for sealing a telecommunications product that has a non-activated shrink wrap tubing positioned over a cable and an opening. The apparatus comprises a frame; heat blasters attached to the frame and movable with respect to the frame in both a first plane and a second plane, the second plane being orthogonal to the first plane, each heat blaster having a heat generator at a first end and an air deflector at a second end; and a controller having at least one processing unit, and a system memory storing instructions that, when executed by the at least one processor, cause the heat blasters to: move along the first plane relative to the telecommunications product; move along the second plane relative to the telecommunications product; and deliver hot air from the heat generator and through the air deflector to activate the shrink wrap tubing and to seal the cable and the opening.

The air deflectors can each have a slit opening. The slit opening can have a center portion and terminal ends, the width of the terminal ends are wider than the center portion. The air deflectors can each have a flat bottom portion and a sloped top portion that direct the flow of hot air through a slit opening. The air deflectors can each have a semi-circular shape and a slit opening that delivers hot air in a 180 degree direction. The heat blasters may be positioned at opposite sides of the frame, such that when moved together along the first plane, the heat blasters deliver hot air in a 360 degree direction around the opening of the telecommunications product.

The instructions may further cause the heat blasters to perform a heat profile that varies the amount of time that the hot air is delivered to sections of the shrink wrap tubing along the second plane. The heat profile can include delivering the hot air to a first section of the shrink wrap tubing before delivering the hot air to a second section of the shrink wrap tubing, the second section being farther away from an interior space of the telecommunications product than the first section The heat profile can include delivering the hot air at a constant temperature of about 100° C. to about 140° C. for a variable amount of time along a predetermined length of the shrink wrap tubing.

The apparatus may further comprise an attachment device having a back plate and side panels configured to at least partially surround the telecommunications product, and wherein the attachment device includes a clamp that secures the telecommunications product to the back plate, and a heat shield that covers a top portion of the telecommunications product.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the examples disclosed herein are based.

### DESCRIPTION OF THE FIGURES

The following drawing figures, which form a part of this application, are illustrative of described technology and are not meant to limit the scope of the disclosure in any manner.

FIG. 1 is an isometric view of an apparatus that performs a sealing operation for a telecommunications product.

FIG. 2 is another isometric view of the apparatus of FIG. 1.

FIG. 3 is a front view of the apparatus of FIG. 1.

FIG. 4 is a side view of the apparatus of FIG. 1.

FIG. 5 is an isometric view of an attachment device that secures the telecommunications product to the apparatus.

FIG. 6 is another isometric view of the attachment device.

FIG. 7 is a detailed isometric view of a frame of the apparatus.

FIG. 8 is an isometric view of a support bracket and heat blaster assembly.

FIG. 9 is a front view of the support bracket and heat blaster assembly.

FIG. 10 is a side view of the support bracket and heat blaster assembly.

FIG. 11 is an isometric view of a heat blaster

FIG. 12 is an isometric view of an air deflector.

FIG. 13 is a side view of the air deflector.

FIG. 14 is a top view of the air deflector.

FIG. 15 is a front view of the air deflector.

FIG. 16 illustrates a method for manufacturing a telecommunications closure.

FIG. 17 illustrates a heat sealing operation.

FIG. 18 illustrates the components of a controller of the apparatus.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

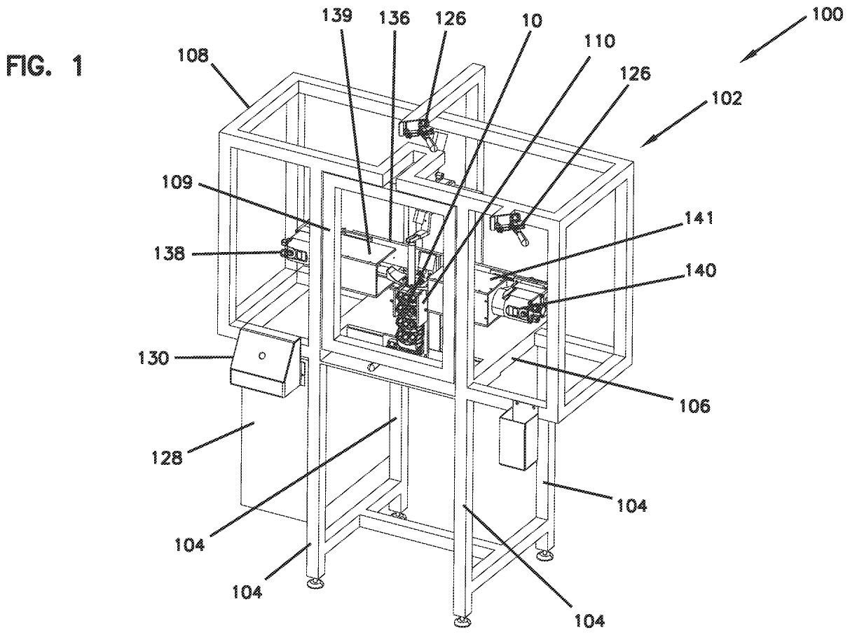

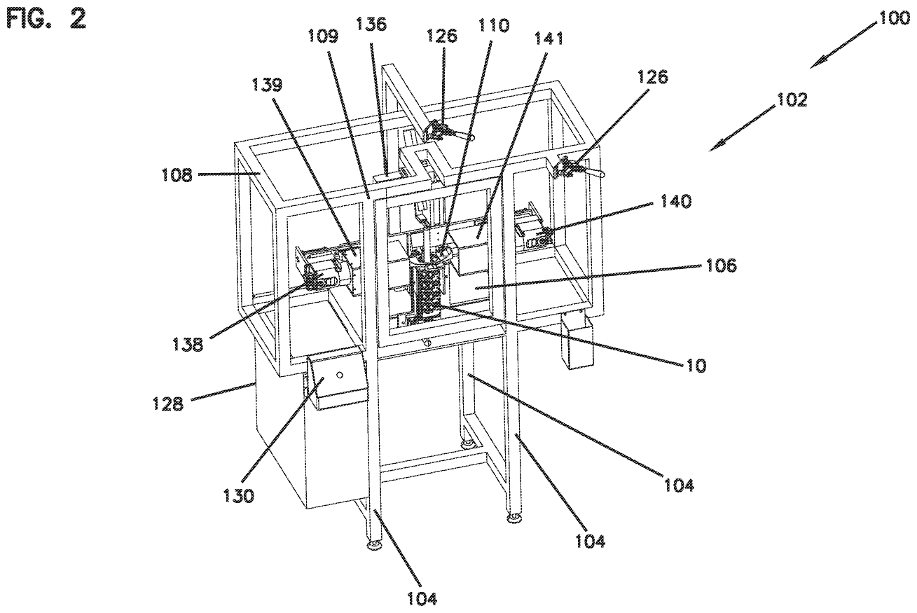

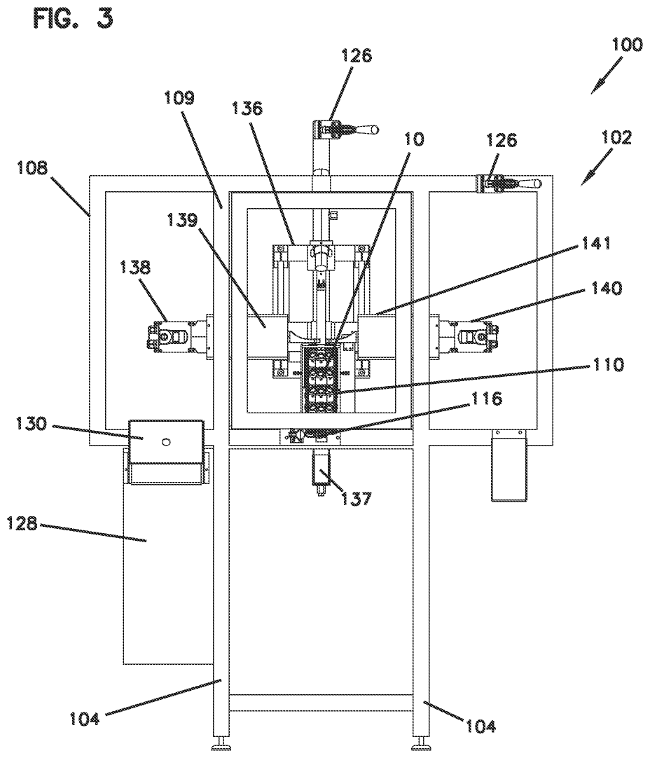

FIGS. 1-4 are isometric, front, and side views, respectively, of an apparatus 100 that performs a sealing operation for a telecommunications product 10. The apparatus 100 includes a frame 102 having legs 104 that support a base 106 from the ground. The frame 102 further includes a cage 108 that surrounds the base 106. The cage 108 may include a barrier that surrounds the base 106 and is see-through such that the barrier provides visibility of the telecommunications product 10 while also functioning to protect workers during operation of the apparatus 100 by blocking limbs from touching the telecommunications product 10 when inside the cage 108. The cage 108 may include a door 109 that can also have a barrier. The door 109 can open and close to provide access to the telecommunications product 10.

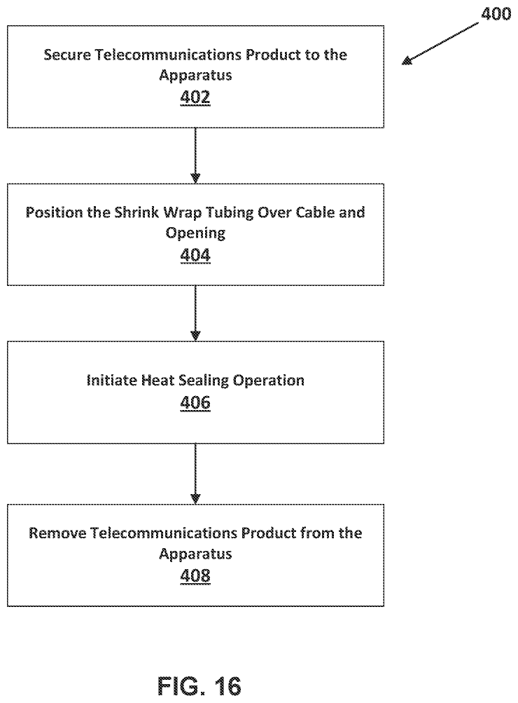

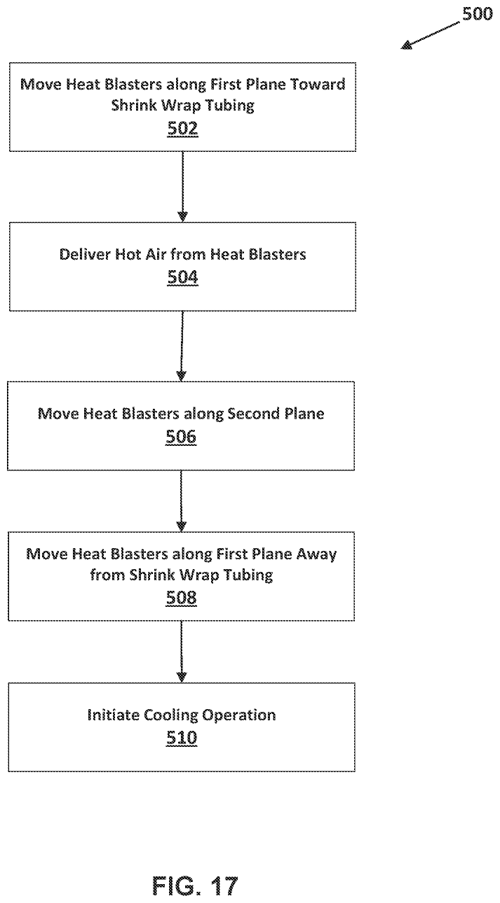

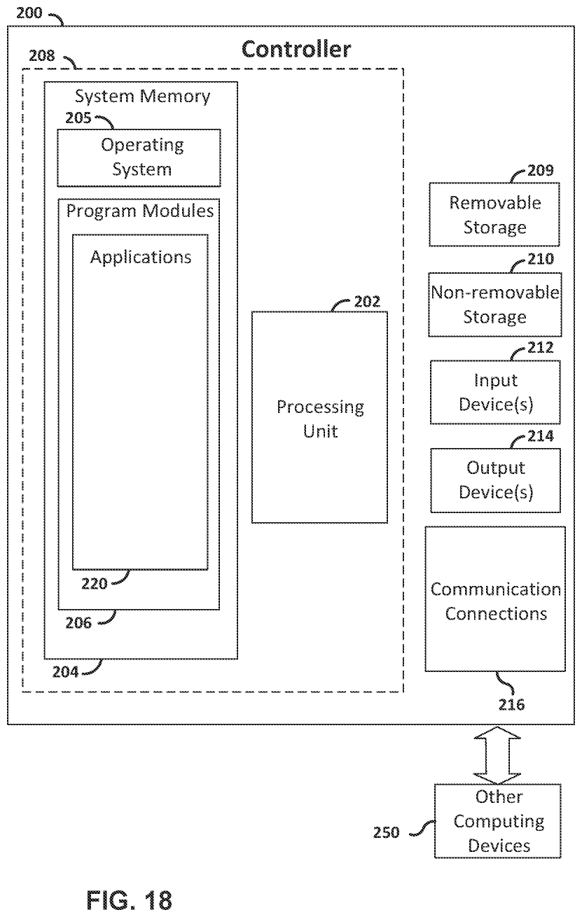

As further shown in FIGS. 1-4, a housing 128 is attached to the frame 102. The housing 128 includes a control panel 130 that includes input devices such as an on/off switch and other controls that can be used by a worker to operate the apparatus 100. The housing 128 also stores a controller 200 (see FIG. 18) having at least one processing unit 202 and a system memory 204 storing instructions that, when executed by the processing unit 202, cause the apparatus 100 to perform one more methods related to the manufacturer of the telecommunications product 10. Such methods will be described in more detail with reference to FIGS. 16 and 17. The controller 200 will be described in more detail with reference to FIG. 18.

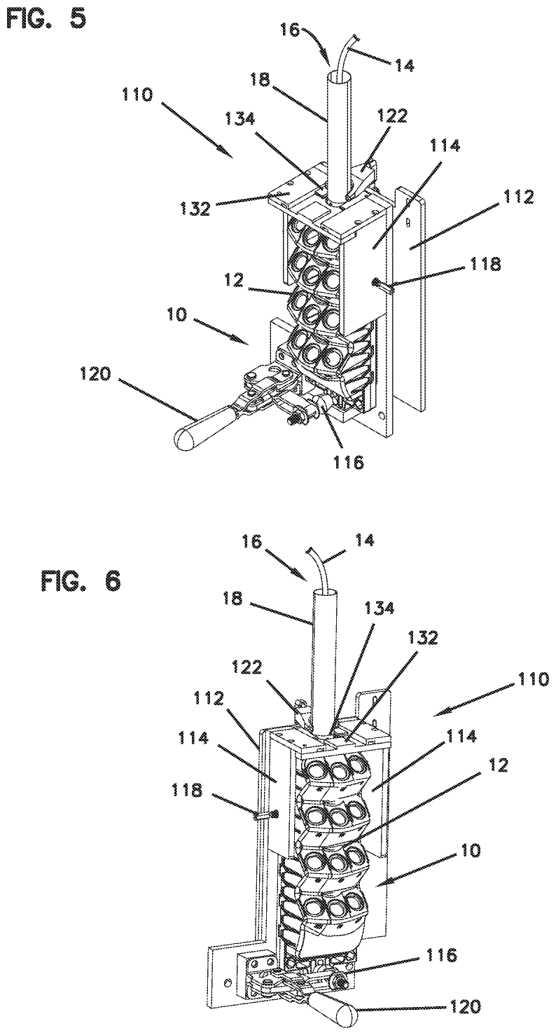

FIGS. 5 and 6 show isometric views of an attachment device 110 that secures the telecommunications product 10 to the base 106 of the apparatus 100. As shown in FIGS. 5 and 6, the telecommunications product 10 includes a body 12 that defines an interior space. At least one cable 14 extends from the interior space to an exterior of the body 12 through an opening 16 having a tubular body. A non-activated shrink wrap tubing 18 positioned over a cable 14 and the opening 16. In certain examples, the telecommunications product 10 is a closure.

The attachment device 110 has a back plate 112 and side panels 114 that at least partially surround the telecommunications product 10. The attachment device 110 may include a clamp 116 that secures the telecommunications product 10 to the back plate 112. In the example shown, the clamp 116 includes a lever 120 that can be operated by a worker to secure the telecommunications product 10 to the back plate 112. The attachment device 110 may also include bolts 118 that secure the telecommunications product 10 to the side panels 114. The bolts 118 can be twisted in clockwise or counterclockwise directions to secure and release the telecommunications product 10 from the side panels 114. Other configurations are possible.

Still referring to FIGS. 5 and 6, the attachment device 110 further includes a heat shield 132 that covers a top portion of the telecommunications product 10. The heat shield 132 includes an opening 134 that allows the tubular body of the opening 16 to extend through. The heat shield 132 functions to protect the body 12 of the telecommunications product 10 from heat.

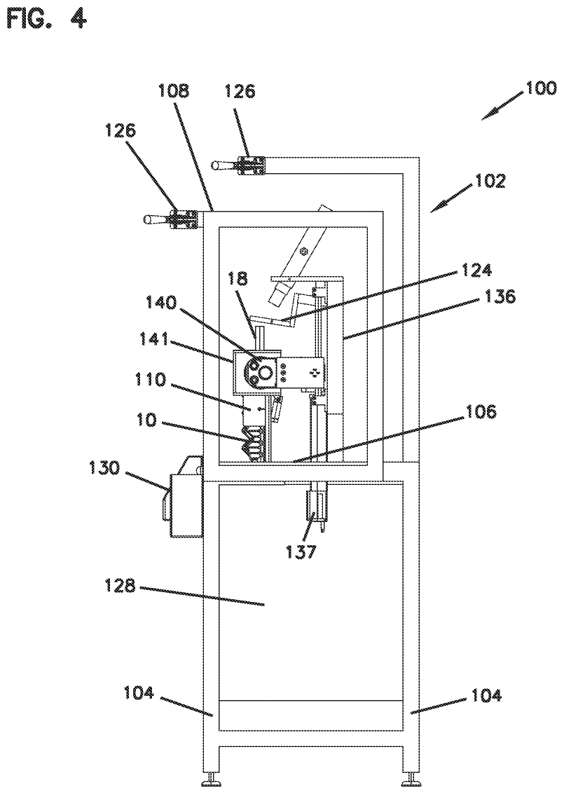

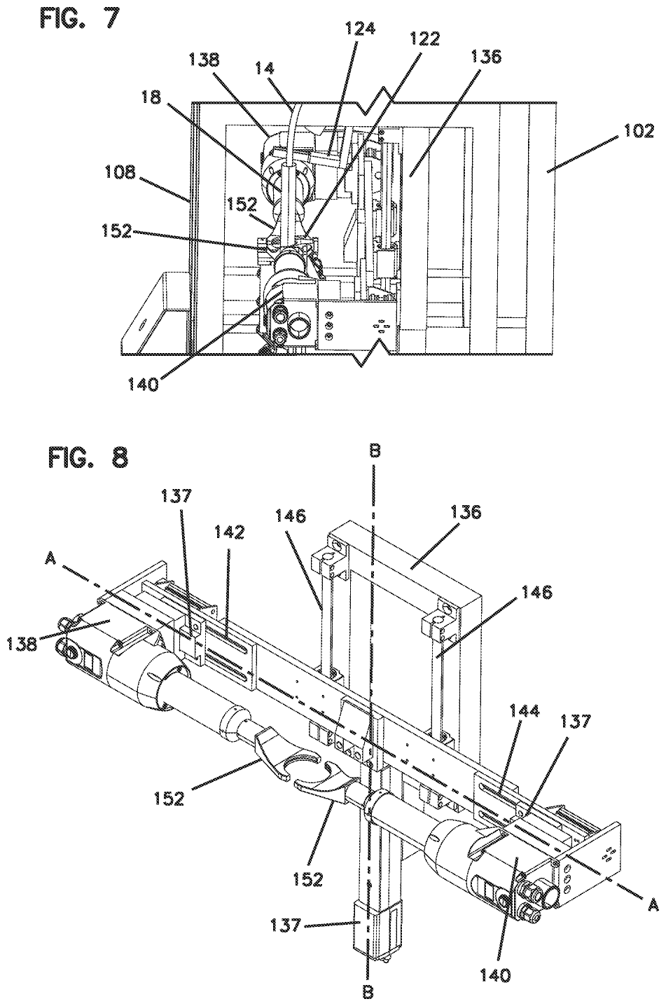

FIG. 7 is a detailed isometric view of the frame 102. The frame 102 may include a handle 122 that can at least partially surround the shrink wrap tubing 18 (see also FIGS. 5 and 6). The handle 122 holds the shrink wrap tubing 18 to prevent it from sliding up. Also, the frame 102 may include a handle 124 (see also FIG. 4) that guides the cable 14 from the opening 16 of the telecommunications product 10, and that also prevents the shrink wrap tubing 18 from sliding up during a heat sealing operation. As shown in FIGS. 1-4, the frame 102 may further include one or more additional clamps 126 for securing the cable 14 to the frame 102 of the apparatus 100.

As shown in FIGS. 1-4, the frame 102 further includes bracket 136 that supports a first heat blaster 138 and a second heat blaster 140. The first heat blaster 138 and the second heat blaster 140 are each partially covered by shields 139, 141, respectively. Advantageously, the shields 139, 141 protect the heat blasters 138, 140, and also block the hot air emitted from the heat blasters 138, 140 from reaching and injuring workers stationed at the apparatus 100.

In the examples depicted in the figures, the apparatus 100 includes two heat blasters 138, 140 that are positioned on opposite sides of the attachment device 110. Other configurations are possible. For example, the apparatus 100 may include more than two heat blasters or fewer than two heat blasters. Additionally, the heat blasters may be positioned at different locations in the apparatus 100 with respect to the base 106 and telecommunications product 10.

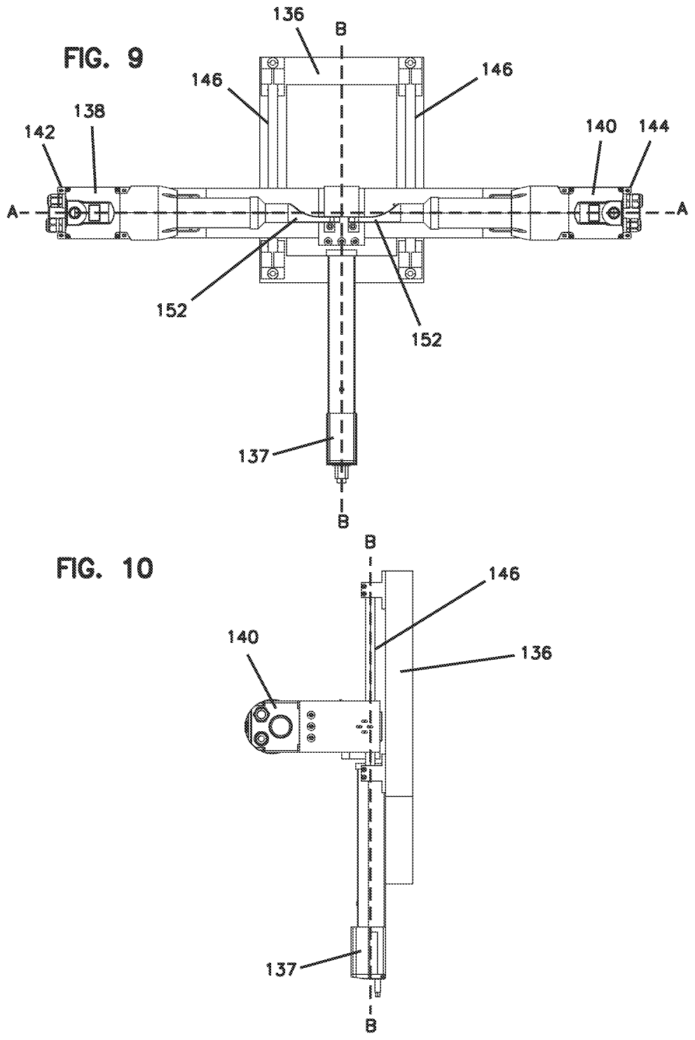

FIGS. 8-10 are isometric, front, and side views of the bracket 136 and the heat blasters 138, 140 attached thereto. In the configuration of FIGS. 8-10, the bracket 136 includes a first rail 142 and a second rail 144 that both extend in a first plane A-A. The bracket 136 further includes a third set of rails 146 that extend in a second plane B-B that is orthogonal to the first plane A-A.

The first heat blaster 138 is connected to the first rail 142 by a programmable linear actuator 137 such that the first heat blaster 138 is movable in forward and reverse directions (e.g., left and right) with respect to the base 106 in the first plane A-A. The second heat blaster 140 is connected to the second rail 144 by another programmable linear actuator 137 such that the second heat blaster 140 is moveable in forward and reverse directions (e.g., left and right) with respect to the base 106 in the first plane A-A. Additionally, the first heat blaster 138 and the second heat blaster 140 are both connected to the third set of rails 146 such that the first heat blaster 138 and the second heat blaster 140 are moveable in forward and reverse directions (e.g., up and down) with respect to the base 106 in the second plane B-B.

The programmable linear actuators 137 are separately controlled by the controller 200. Thus, the first heat blaster 138 and the second heat blaster 140 are moveable in the first plane A-A and the second plane B-B in accordance the instructions stored in the system memory 204. In some examples, the programmable linear actuators 137 are pneumatic cylinders or hydraulic cylinders. In further examples, the programmable linear actuators 137 are ROBO Cylinders®. In one example, the programmable linear actuator 137 that controls the movement of the first heat blaster 138 and the second heat blaster 140 on the third set of rails 146 is a ROBO Cylinders®.

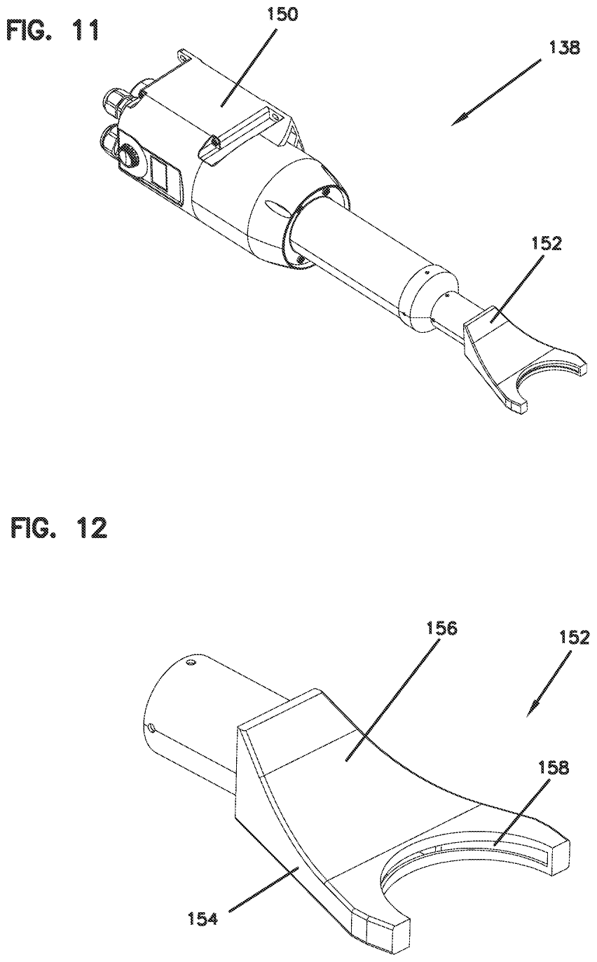

FIG. 11 is an isometric view of the first heat blaster 138. The second heat blaster 140 is the same as the first heat blaster 138, and therefore the description of the first heat blaster 138 is applicable to the second heat blaster 140. As shown in FIG. 11, the first heat blaster 138 includes a heat generator 150 at a first end and an air deflector 152 at a second end. The heat generator 150 generates hot air that is delivered through the air deflector 152 to activate the shrink wrap tubing 18 positioned over the cable 14 and the opening 16. Accordingly, the hot air emitted from the heat blaster seals the cable 14 to the telecommunications product 10.

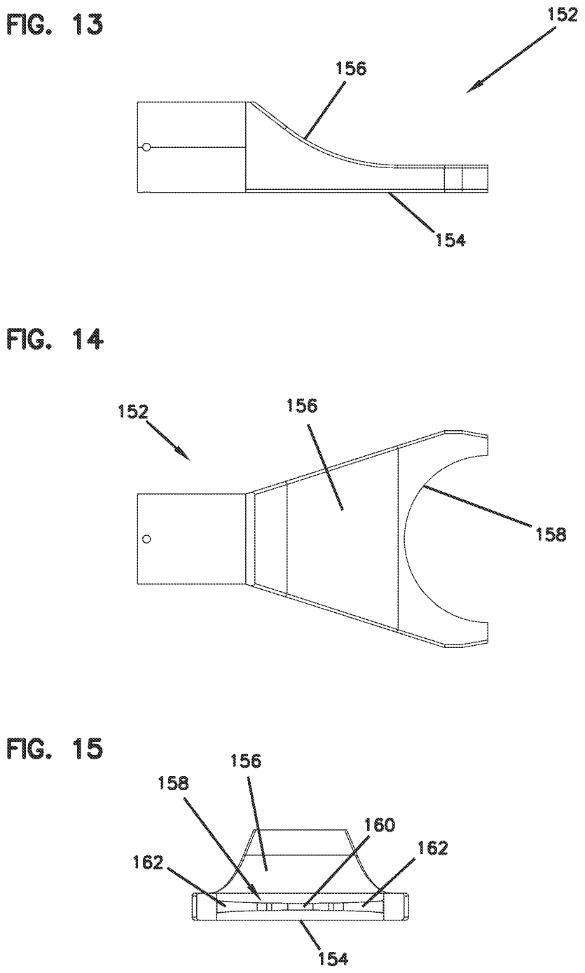

FIGS. 12-15 are isometric, side, top, and front views of the air deflector 152. As shown in FIGS. 12-15, the air deflector 152 has a flat bottom portion 154 and a sloped top portion 156 that direct the flow of hot air through a slit opening 158. Advantageous, the flat bottom portion 154 of the air deflector 152 is substantially parallel to the heat shield 132 such that air deflector 152 can reach the bottom of the shrink wrap tubing 18 positioned over the cable 14 and the opening 16 without interfering with the heat shield 132. Accordingly, the first and second heat blasters 138, 140 to move in the forward and reverse directions (e.g., left and right) with respect to the base 106 in the first plane A-A without interfering with the heat shield 132.

As shown in FIG. 14, the air deflector 152 has a semi-circular shape such that the slit opening 158 delivers the hot air in a 180 degree direction. Referring now to FIGS. 8 and 14, when the first heat blaster 138 and the second heat blaster 140 move in close proximity to one another along the first plane A-A, the air deflectors 152 partially or fully encircle the exterior of the shrink wrap tubing 18. Accordingly, the first and second heat blasters 138, 140 deliver hot air in a substantially 360 degree direction around the exterior of the shrink wrap tubing 18.

As shown in FIG. 15, the slit opening 158 has a center portion 160 having a first width and terminal ends 162 having a second width that is larger than the first width. Advantageously, the larger width of the terminal ends 162 applies a more consistent and evenly distributed heat flow (e.g., in the substantially 360 degree direction) around the shrink wrap tubing 18.

As described above, the controller 200 includes at least one processing unit 202 and a system memory 204 storing instructions that, when executed by the processing unit 202, cause the apparatus 100 to perform one or more methods related to the manufacturer of the telecommunications product 10. These methods will now be described with reference to FIG. 16 which illustrates a method 400 for sealing the telecommunications product 10. In addition to sealing the telecommunications product 10, it is contemplated that the method 400 may be used to seal a variety of telecommunications products and is therefore not limited to the telecommunications product 10.

The method 400 includes a step 402 of securing the telecommunications product 10 to the apparatus 100. As described above, the telecommunications product 10 can be secured to the apparatus 100 using the attachment device 110 (see FIGS. 5 and 6). For example, a worker can use the lever 120 to operate the clamp 116 to secure the telecommunications product 10 to the back plate 112 of the attachment device 110. Additionally, the worker can twist the bolts 118 in a clockwise or counterclockwise direction to secure the telecommunications product 10 to the side panels 114 attachment device 110. Also, the worker can use the one or more additional clamps 126 to secure the cable 14 to the frame 102 of the apparatus 100 (see FIGS. 1-4).

Next, the method 400 includes a step 404 of positioning the shrink wrap tubing 18 over an outside surface of the cable 14 and over an outside surface of the tubular body of the opening 16. As shown in FIGS. 5 and 6, the shrink wrap tubing 18 has a predetermined length that extends past the length of the tubular body of the opening 16 such that the shrink wrap tubing 18 covers both the tubular body of the opening 16 and the cable 14.

Next, the method 400 includes a step 406 of initiating a heat sealing operation 500. The heat sealing operation 500 may be initiated by a worker utilizing the controls (e.g., the on/off switch) in the housing 128. FIG. 17 illustrates the heat sealing operation 500 in more detail.

After completion of the heat sealing operation 500, the method 400 includes a step 408 of removing the telecommunications product 10 from the apparatus 100. Step 408 may include a worker using the lever 120 to operate the clamp 116 to detach the telecommunications product 10 from the back plate 112 of the attachment device 110. Also, the worker can twist the bolts 118 in a clockwise or counterclockwise direction to detach the telecommunications product 10 from the side panels 114 attachment device 110. Additionally, the worker can use the additional clamps 126 to detach the cable 14 from the frame 102 of the apparatus 100.

FIG. 17 illustrates the heat sealing operation 500. As shown in FIG. 17, the heat sealing operation 500 includes a step 502 of moving the heat blasters 138, 140 along the first plane A-A such that the heat blasters 138, 140 move toward the shrink wrap tubing 18 until the heat blasters 138, 140 surround the shrink wrap tubing 18. The semi-circular shape of the air deflectors 152 allow the air deflectors 152 to surround the shrink wrap tubing 18 in a 360 degrees direction.

As described, the programmable linear actuators 137 are separately controlled by the controller 200 such that the heat blasters 138, 140 move on the first rail 142 and second rail 144, respectively, toward one another.

Next, the heat sealing operation 500 includes a step 504 of delivering hot air from each of the heat blasters 138, 140. As described above, the heat blasters 138, 140 each include a heat generator 150 that generates the hot air, and an air deflector 152 that delivers the hot air to activate the shrink wrap tubing 18. Each air deflector 152 has a semi-circular shape such that the slit opening 158 delivers the hot air in a 180 degree direction. Accordingly, the heat blasters 138, 140 deliver the hot air in a 360 degree direction around the shrink wrap tubing 18.

Next, the heat sealing operation 500 includes a step 506 of moving the heat blasters along the second plane B-B along a predetermined length of the shrink wrap tubing 18. The second plane B-B is orthogonal to the first plane A-A, and a programmable linear actuator 137 controlled by the controller 200 moves the heat blasters 138, 140 on the third set of rails 146.

During step 506, the hot air from each heat blaster 138, 140 is delivered according to a heat profile that varies the time the hot air is delivered along the second plane B-B. The heat profile can be stored in the system memory 204 of the controller 200. The heat profile delivers the hot air at a constant temperature along the predetermined length of the shrink wrap tubing 18. For example, the heat profile may include delivering the hot air at about 100° C. to about 140° C. for a variable amount of time along the second plane. In one example, the heat profile includes delivering the hot air to the distal ends of the shrink wrap tubing 18 for a first predetermined period of time, and delivering the hot air to central sections of the shrink wrap tubing 18 for a second predetermined period of time, the first predetermined period of time being larger than the second predetermined period of time.

In another example, the heat profile may include delivering the hot air to a first section of the shrink wrap tubing 18 before delivering the hot air to a second section of the shrink wrap tubing 18, the second section being farther away from the interior space of the telecommunications product 10 than the first section. Upon delivery of the hot air, the shrink wrap tubing 18 is activated and produces a seal between the opening 16 and the cable 14 that is water and contaminant (e.g., dust) proof and/or water-resistant.

After completion of the heat profile in step 506, the delivery of hot air from the heat blasters 138, 140 is stopped (e.g., the heat blasters 138, 140 are turned off), and the heat sealing operation 500 includes a step 508 of moving the heat blasters 138, 140 away from the shrink wrap tubing 18 along the first plane A-A. In accordance with the above description, the programmable linear actuators separately controlled by the controller 200 move the heat blasters 138, 140 on the first rail 142 and second rail 144, respectively, away from one another.

Thereafter, the heat sealing operation 500 includes a step 510 of initiating a cooling operation. In some examples, the cooling operation in step 506 may include waiting for a predetermined amount of time for the shrink wrap tubing 18 to cool down. Afterwards, the telecommunications product 10 can be removed from the apparatus 100 (see step 408).

FIG. 18 is a block diagram illustrating physical components (i.e., hardware) of the controller 200 with which embodiments of the disclosure may be practiced. In certain examples, the controller 200 is a programmable logic controller (PLC) or similar type of device.

In a basic configuration, the controller 200 may include at least one processing unit 202 and a system memory 204. The system memory 204 may include, but is not limited to, volatile storage (e.g., random access memory), non-volatile storage (e.g., read-only memory), flash memory, or any combination of such memories.

The system memory 204 may include an operating system 205 and one or more program modules 206 suitable for running software applications 220. This basic configuration is illustrated in FIG. 18 by those components within a dashed line 208. The controller 200 may have additional features or functionality. For example, the controller 200 may also include additional data storage devices (removable and/or non-removable) such as, for example, magnetic disks, optical disks, or tape. Such additional storage is illustrated by a removable storage device 209 and a non-removable storage device 210.

A number of program modules and data files may be stored in the system memory 204. While executing on the at least one processing unit 202, the program modules 206 may perform various methods and processes including, but not limited to, the methods described with reference to the figures as described herein.

The controller 200 may also have one or more input device(s) 212, such as a keyboard, a mouse, a pen, a sound or voice input device, a touch or swipe input device, etc. Output device(s) 214 such as a display, speakers, a printer, etc. may also be included. The aforementioned devices are examples and others may be used.

The controller 200 may also include one or more communication connections 216 allowing communications with other computing devices 250. Examples of suitable communication connections 216 include, but are not limited to, RF transmitter, receiver, and/or transceiver circuitry; universal serial bus (USB), parallel, and/or serial ports.

The term computer readable media as used herein may include non-transitory computer storage media. Computer storage media may include volatile and nonvolatile, removable and non-removable media implemented in any method or technology for storage of information, such as computer readable instructions, data structures, or program modules. The system memory 204, the removable storage device 209, and the non-removable storage device 210 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the controller 200. Any such computer storage media may be part of the controller 200. Computer storage media does not include a carrier wave or other propagated or modulated data signal.

The block diagram depicted in FIG. 18 is just an example. There may be many variations to this diagram without departing from the spirit of the disclosure. For instance, components may be added, deleted or modified. Further, the description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application.

The various embodiments described above are provided by way of illustration only and should not be construed to limit the claims attached hereto. Those skilled in the art will readily recognize various modifications and changes that may be made without following the example embodiments and application illustrated and described herein, and without departing from the true spirit and scope of the following claims.

1. A method for sealing a telecommunications product, the telecommunications product defining an interior space and having at least one cable extending from the interior space to an exterior through an opening having a tubular body, the method comprising:
securing the telecommunications product to an apparatus, the apparatus including heat blasters each configured to emit hot air;
positioning a shrink wrap tubing of a predetermined length over an outside surface of the cable and an outside surface of the tubular body of the opening; and
initiating a heat sealing operation that includes:
moving the heat blasters along a first plane toward the shrink wrap tubing until the heat blasters surround the shrink wrap tubing;
delivering hot air from each heat blaster; and
moving the heat blasters along a second plane along a predetermined length of the shrink wrap tubing, the second plane orthogonal to the first plane.

2. The method of claim 1, wherein the heat sealing operation includes delivering the hot air in a 360 degree direction around the shrink wrap tubing.

3. The method of claim 2, further comprising delivering the hot air from each heat blaster according to a heat profile that varies the time the hot air is delivered along the second plane.

4. The method of claim 3, wherein the heat profile delivers the hot air at a constant temperature along the predetermined length of the shrink wrap tubing

5. The method of claim 3, wherein the heat profile includes delivering the hot air at about 100° C. to about 140° C. for a variable amount of time along the second plane.

6. The method of claim 3, wherein the heat profile includes delivering the hot air to a first section of the shrink wrap tubing before delivering the hot air to a second section of the shrink wrap tubing, the second section being farther away from the interior space of the telecommunications product than the first section.

7. The method of claim 3, wherein the heat profile includes delivering the hot air to distal ends of the shrink wrap tubing for a first predetermined period of time, and delivering the hot air to central sections of the shrink wrap tubing for a second predetermined period of time, the first predetermined period of time being larger than the second predetermined period of time.

8. The method of claim 1, further comprising using a clamp to secure the telecommunications product to the apparatus.

9. The method of claim 1, further comprising using a clamp to secure the at least one cable to a frame of the apparatus.

10. The method of claim 1, further comprising:
moving the heat blasters away from the shrink wrap tubing along the first plane;
initiating a cooling operation; and
removing the telecommunications product from the apparatus.

11. An apparatus for sealing a telecommunications product that has a non-activated shrink wrap tubing positioned over a cable and an opening, the apparatus comprising:
a frame;
heat blasters attached to the frame and movable with respect to the frame in both a first plane and a second plane, the second plane being orthogonal to the first plane, each heat blaster having a heat generator at a first end and an air deflector at a second end; and
a controller having at least one processing unit and a system memory storing instructions that, when executed by the at least one processor, cause the heat blasters to:
move along the first plane relative to the telecommunications product;
move along the second plane relative to the telecommunications product; and
deliver hot air from the heat generator and through the air deflector to activate the shrink wrap tubing and seal the cable and the opening.

12. The apparatus of claim 11, wherein the air deflectors each have a slit opening.

13. The apparatus of claim 12, wherein the slit opening has a center portion and terminal ends, the width of the terminal ends being wider than the center portion.

14. The apparatus of claim 12, wherein the air deflectors each have a flat bottom portion and a sloped top portion that direct the flow of hot air through a slit opening.

15. The apparatus of claim 12, wherein the air deflectors each have a semi-circular shape and a slit opening that delivers hot air in a 180 degree direction.

16. The apparatus of claim 11, wherein the heat blasters are positioned at opposite sides of the frame, such that when moved together along the first plane, the heat blasters deliver hot air in a 360 degree direction around the opening of the telecommunications product.

17. The apparatus of claim 11, wherein the instructions further cause the heat blasters to:
perform a heat profile that varies the amount of time that the hot air is delivered to sections of the shrink wrap tubing along the second plane.

18. The apparatus of claim 17, wherein the heat profile includes delivering the hot air to a first section of the shrink wrap tubing before delivering the hot air to a second section of the shrink wrap tubing, the second section being farther away from an interior space of the telecommunications product than the first section.

19. The apparatus of claim 17, wherein the heat profile includes delivering the hot air at a constant temperature of about 100° C. to about 140° C. for a variable amount of time along a predetermined length of the shrink wrap tubing.

20. The apparatus of claim 11, further comprising an attachment device having a back plate and side panels configured to at least partially surround the telecommunications product, and wherein the attachment device includes a clamp that secures the telecommunications product to the back plate, and a heat shield that covers a top portion of the telecommunications product.
